(19) United States
(12) Patent Application Publication
(10) Pub. No.: US 2026/0055297 A1
(43) Pub. Date: Feb. 26, 2026

(54) COATING SYSTEMS FOR IMPROVING ADHESION BETWEEN COATING LAYERS AND METHODS FOR IMPROVING ADHESION BETWEEN ADJACENT COATING LAYERS

(71) Applicant: SWIMC LLC, Cleveland, OH (US)

(72) Inventors: Liang LIANG, Twinsburg, OH (US); Gunnar DUNER, Independence, MN (US); Hannah R. HOULE, Brooklyn Center, MN (US)

(21) Appl. No.: 19/309,713

(22) Filed: Aug. 26, 2025

Related U.S. Application Data
(60) Provisional application No. 63/687,000, filed on Aug. 26, 2024.

(51) Int. Cl. C09D 175/04; B05D 3/10; B05D 7/00; C09D 5/00

(52) U.S. Cl. CPC C09D 175/04; B05D 3/108; B05D 7/532; B05D 7/542; C09D 5/002

(57) ABSTRACT

A coating system is provided for improving adhesion between adjacent coating layers, where the coating system includes a first coating composition containing a first modified polymer composition having a first functional group, and a second coating composition containing a second modified polymer composition having a second functional group, wherein the first functional group and second functional group are reactive with one another, such that upon formation of a first coating layer from the first coating composition and an adjacent second coating layer from the second coating composition, the first functional group and the second functional group react with one another to bind the first coating layer and second coating layer together at their adjacent surfaces, and methods for improving adhesion between adjacent coating layers using the coating system.

### CROSS REFERENCE TO RELATED APPLICATIONS

The present application is related to, and claims priority to, U.S. Provisional Application Ser. No. 63/687,000, filed Aug. 26, 2024, the contents of which are hereby incorporated by reference in their entirety.

### BACKGROUND OF THE INVENTION

### Field of the Invention

The present invention relates to coating systems for improving the adhesion between adjacent coating layers, particularly water-borne coating layers, and methods for improving the adhesion between adjacent coating layers.

### Description of the Related Art

Polyurethanes (PU) prepared by the reaction between polyol and isocyanate have demonstrated many advantages such as short drying times, a wide range of hardness, abrasion and impact resistance, flexibility, and strong bonding. Therefore, a polyurethane clearcoat is frequently used in a top coating for refinished vehicles. However, one drawback for the use of this technology is the reaction of isocyanate with water or moisture at room temperature. Carbon dioxide is generated as a by-product during this reaction and a film with pore structure is generated, which can significantly decrease mechanical strength of the PU film and makes it extremely difficult to achieve consistence performance of final products. In addition, the use of isocyanate, which is produced from an even more toxic predecessor, phosgene, can create considerable environmental hazards. It is well known that exposure to isocyanates can result in serious health effects such as skin irritation and asthma.

Many efforts have been addressed to develop non-isocyanate polyurethane (NIPU) materials, including coatings, adhesives, sealants, and composites with desirable mechanical and thermal properties. One of the strategies to generate NIPU materials is by the use of a Michael addition reaction. In Michael addition, the primary components are a strong base catalyst, electron rich malonate polyester as Michael donor and electron deficient acryloyl monomers or oligomers as Michael acceptor. Michael addition can be only processed under a basic working environment because the reaction requires a strong base catalyst. Acid compounds or a polymer with acid groups at the interface will thus inhibit the reaction.

A 1K waterborne polyurethane basecoat is frequently used in the application of refinished vehicles. However, there is no reaction at the interface with a top clear coating solution developed by Michael addition and 1K waterborne basecoat due to many carboxyl groups attached on the basecoat. Poor adhesive strength between clearcoat and basecoat is therefore observed, and it is impossible to develop either a solvent or a waterborne non-isocyanate coating solution with strong adhesive strength involving Michael addition on the surface of such a 1K waterborne polyurethane basecoat.

Meanwhile with more strict regulation based on environmental protection, the demand for more waterborne coatings and coating solutions has dramatically increased in recent years. Low VOC (volatile organic compounds) and zero emissions are major advantages of waterborne coating solutions and a primary motivation to develop various waterborne coating solutions in academic and industrial areas. Accordingly, a large amount of effort has been expended in both industrial and academic research fields to replace solvent borne coating solutions with waterborne coating solutions. Several waterborne primers having a structure of PU and hybrid PU-Epoxy have been developed. However, the adhesive strength between basecoats and such waterborne primers has been found to be deficient after humidity chamber testing. Since there is only physical binding at the interface of basecoat and primer, the adhesive strength between basecoat and primer layers can be drastically diminished when the films are subjected to the swelling and shrinking processes found in humidity chamber testing.

There is thus a need in the coatings industry for a coating system that can increase the adhesive strength between adjacent coating layers, particularly between basecoat and primer layers, or between basecoat and clearcoat layers, especially when those layers are waterborne coatings.

### SUMMARY OF THE INVENTION

Accordingly, one object of the present invention is to provide a coating system that can increase the adhesive strength between two adjacent coating layers by the creation of chemical bonding between the layers.

A further object of the invention is to provide such a coating system for increasing the adhesive strength between two adjacent coating layers that can be applied to waterborne coatings.

An additional object of the invention is to provide a method for improving the adhesive strength between adjacent coating layers using such a coating system.

These and other objects and advantages of the invention, either alone or in combinations thereof, may be satisfied by a coating system, comprising:
a first coating composition comprising a first modified polymer composition containing a first functional group, and
a second coating composition comprising a second modified polymer composition containing a second functional group,
wherein the first functional group and second functional group are reactive with one another, such that upon formation of a first coating layer from the first coating composition and an adjacent second coating layer from the second coating composition, the first functional group and the second functional group react with one another to bind the first coating layer and second coating layer together at their adjacent surfaces;
and a method for increasing adhesion between adjacent coating layers using such a coating system.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 provides a graphical representation of Michael addition C—C bond formation reactions of certain embodiments of the invention, in which nucleophilic addition of a carbanion or another nucleophile to an α,β-unsaturated carbonyl compound containing an electron withdrawing group occurs.

FIG. 2 provides a graphical representation of certain embodiments of the invention, showing the structure of the basecoat and clearcoat surfaces modified by their respective functional silanes before and after the reaction at their interface.

FIG. 3 provides a graphical representation of the interface reaction in certain embodiments of the present invention, which improves the adhesive strength between clearcoat and basecoat by chemical reaction of such functional silanes in the interface to create covalent bonds between the clearcoat and basecoat layers.

FIG. 4 provides a graphical representation of the structure of multiple coating layers in certain embodiments of the present invention.

FIG. 5 provides a graphical representation of the general concepts of adhesive failure mode and cohesive failure mode.

FIG. 6 provides a graphical representation of certain embodiments of the present invention in which an etch primer modified by incorporation of a compound (such as a silane) containing an amine group reacts with a primer modified by incorporation of a compound (such as a silane) containing an epoxy group.

FIG. 7 provides a graphical representation of certain embodiments of the present invention in which a primer layer modified by incorporation of a compound (such as a silane) containing an epoxy group reacts with a basecoat layer modified by incorporation of a compound (such as a silane) containing an amine group.

FIG. 8 shows a graphical representation of the interface reaction which improves the adhesive strength between primer and basecoat by chemical reaction of such functional silanes in the interface to create covalent bonds between the primer and basecoat layers.

FIG. 9 provides the structures of two different silanes, with each one being used in a separate clearcoat formulation in certain embodiments of the present invention.

FIG. 10 provides a graphical representation of the structure of the basecoat and clearcoat coating layers on the substrate panels in certain embodiments of the present invention.

FIG. 11 provides a graphical representation of the reaction between isocyanate groups on the clearcoat and amine groups on the basecoat in certain embodiments of the present invention.

### DETAILED DESCRIPTION OF THE PREFERRED EMBODIMENTS

The present invention relates to a coating system having improved adhesion between coating layers by using chemical functionality of adjacent coating layers to bind the coating layers to one another. In particular embodiments, the coating system comprises a first coating composition comprising a first modified polymer composition containing a first functional group, and a second coating composition comprising a second modified polymer composition containing a second functional group. In the coating system, the first functional group and second functional group are reactive with one another, such that upon formation of a first coating layer from the first coating composition and an adjacent second coating layer from the second coating composition, the first functional group and the second functional group react with one another to bind the first coating layer and second coating layer together at their adjacent surfaces.

The first coating composition and the second coating composition are each, independently, a polymer based composition that can be used to form a coating. The polymer used in the coating compositions can be any desired polymer, so long as the polymer can be provided with a functional group that will be active at a surface of a coating formed from the coating composition containing the polymer. A consideration for improving the adhesion between such adjacent layers formed from the first and second coating compositions is providing the first coating composition with a first functional group and the second coating composition with a second functional group, wherein the first functional group and second functional group are reactive with one another. This reactivity provides the binding desired between the adjacent coating layers formed from the respective first and second coating compositions.

In certain embodiments, the first functional group is, independently, a member selected from the group consisting of amino groups, hydroxyl groups, carboxyl groups, aldehyde groups, acid anhydride groups, N-succinimide carboxylate groups, carbodiimide groups, isocyanate groups, and epoxy groups. In certain embodiments, the second functional group is, independently, a member selected from the group consisting of amino groups, hydroxyl groups, carboxyl groups, aldehyde groups, acid anhydride groups, N-succinimide carboxylate groups, carbodiimide groups, isocyanate groups, and epoxy groups, and is selected to be reactive with the first functional group. Accordingly, in certain embodiments, the first functional group is an epoxy group and the second functional group is an amine group. Upon forming the adjacent coating layers, the epoxy group and the amine group react by amine attack at the epoxy carbon to open the epoxy ring and form an hydroxyl containing linkage covalently binding the two coating layers together. In certain embodiments, the first functional group is an isocyanate group and the second functional group is an amine group. When the adjacent coating layers are then formed, the amine group reacts with the isocyanate to form a urethane linkage covalently binding the two coating layers together.

In certain embodiments, the first coating composition and the second coating composition can be waterborne coating compositions or solvent-borne compositions. In certain embodiments, the first coating composition and the second coating composition are each, independently, selected from the group consisting of polyurethane compositions, epoxy resin compositions, polysiloxane resin compositions, hybrid epoxy-polyurethane compositions, hybrid polyurethane-polysiloxane compositions, hybrid epoxy-polysiloxane compositions, hybrid epoxy-polyurethane compositions, and polyacrylic resin compositions. Any combination of coating compositions can be used as the first coating composition and second coating composition, partially depending on the desired end use for the coatings.

In certain embodiments, the first coating composition is a first polyurethane composition. In some embodiments, the first polyurethane composition is a waterborne first polyurethane composition. In other embodiments, the first polyurethane composition is a solvent-borne polyurethane composition. In certain embodiments, the first polyurethane composition is a waterborne hybrid polyurethane-silane composition.

In certain embodiments, the second coating composition is a second polyurethane composition. In various embodiments, the second polyurethane composition can be any one of a waterborne second polyurethane composition, a waterborne hybrid polyurethane-silane composition, or a solvent-borne second polyurethane composition.

The first coating composition and second coating composition can form any two adjacent coating layers, including, but not limited to, etch primer/primer, primer/basecoat, or basecoat/clearcoat combinations. In certain preferred embodiments, the first coating layer is a primer layer and the second coating layer is a basecoat layer. In other preferred embodiments, the first coating layer is a basecoat layer and the second coating layer is a clearcoat layer.

The present invention further relates to a method for improving the adhesion between adjacent coating layers. In the method of certain embodiments, the method comprises forming a first coating layer on at least a portion of a substrate with a first coating composition comprising a modified polymer composition containing a first functional group and curing the first coating layer sufficiently to accept a second coating layer; forming the second coating layer on the first coating layer with a second coating composition comprising a modified polymer composition containing a second functional group, curing the first and second coating layers, such that the first functional group and second functional group react with one another to bind the first coating layer and second coating layer to one another at their adjacent surfaces. In certain embodiments, the substrate has already been coated with one or more layers, such as an etch primer and/or primer layer, prior to forming the first coating layer, such that the substrate to which the first coating layer is applied is a previously coated substrate. The first coating composition and second coating composition used in the method can be any of the first and second coating compositions described above.

In certain preferred embodiments, the first coating layer is a primer layer, applied either directly to the substrate or to an etch primer layer on a surface of the substrate. In such embodiments, the second coating layer is a basecoat layer applied onto the primer layer. In other preferred embodiments, the first coating layer is a basecoat layer, typically applied to an already formed primer layer, with the second coating layer being a clearcoat layer applied onto the basecoat layer.

In certain embodiments of the invention, the coating system is for improving the adhesion between a clearcoat and a basecoat, particularly using different silane containing compounds added into each of the clearcoat and basecoat compositions. In certain embodiments, the clearcoat and/or the basecoat can be a PU composition, and preferably can be a PU composition formed with the use of Michael addition reactions.

In other embodiments of the invention the coating system is for improving the adhesion between a basecoat and a primer, particularly using different silane containing compounds added into each of the basecoat and primer compositions, particularly waterborne basecoat and primer compositions. By introducing silanes with functional groups at basecoat and primer separately, the adhesive strength between basecoat and primer can be fundamentally improved by chemical bonding developed by the reaction with functional groups in silane.

Improving Adhesive Strength Between Clearcoat and Basecoat with Functional Silane.

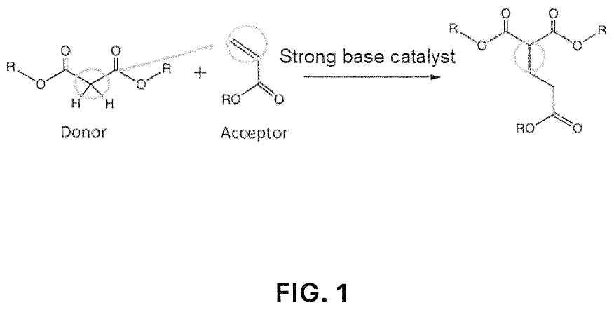

Michael additions are C—C bond formation reactions in which nucleophilic addition of a carbanion or another nucleophile to an α,β-unsaturated carbonyl compound containing an electron withdrawing group occurs as shown in FIG. 1. Strong base catalyst is released when the coating solution is sprayed on substrate panels due to evaporation of CO₂. Then, the base catalyst will attack a proton at the active hydrogens in the donor (in the circle) and the resulting anion will attack the B position (in the circle) of the acceptor to generate a new C—C bond.

However, the Michael addition reaction will be terminated if the strong base catalyst is neutralized by an acid compound, since this results in no active species that can attack the donor active hydrogens. Some acidic carboxyl groups are found on the surface of conventional PU waterborne basecoats at a calculated percentage of carboxyl group on the PU surface of 5% or more.

Accordingly, these acidic carboxyl groups, COOH, on the PU surface can react with the base catalyst indicated in FIG. 1 to de-activate the catalyst. Consequently, this can result in no polymerization at the interface between clearcoat and basecoat and poor adhesive strength between clearcoat and basecoat is observed.

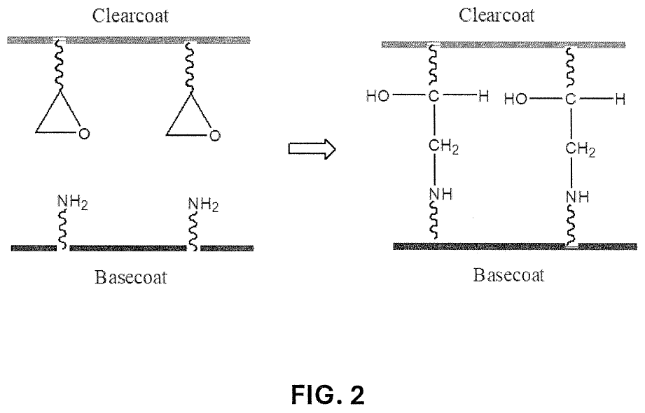

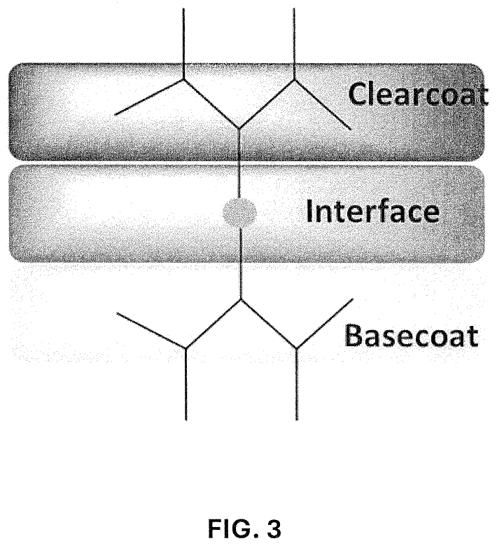

In certain embodiments of the invention, to enhance the adhesive strength between clearcoat and basecoat, a silane compound with a first functional group, such as an amine functional group, is added to the basecoat and a silane compound having a second functional group reactive with the first functional group, such as an epoxide group, is mixed with the solution of the clearcoat. FIG. 2 shows a representation of the structure of the basecoat and clearcoat surfaces modified by their respective functional silanes before and after the reaction at their interface. FIG. 3 shows a graphical representation of the interface reaction which improves the adhesive strength between clearcoat and basecoat by chemical reaction of such functional silanes in the interface to create covalent bonds between the clearcoat and basecoat layers.

There is also a challenge relating to the adhesive strength between basecoat and primer layers, particularly waterborne primer layers, after humidity testing. It has been found that the adhesive strength loss between basecoat and primer is significant after humidity testing. Additionally, the adhesive strength between basecoat and clearcoat becomes even worse after the sample is exposed at room temperature for extended periods of time. Theoretically, the adhesive strength should recover after exposure at room temperature for extended periods of time since water moisture inside the films gradually evaporates, and the resulting dried film should demonstrate better adhesive strength than the wet film.

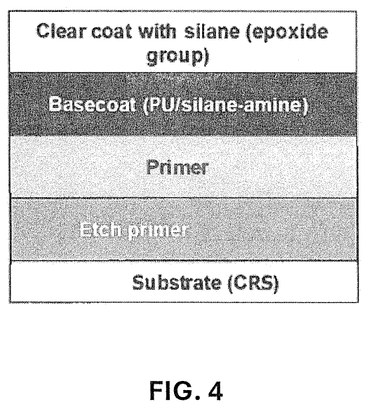

One hypothesis for this poor adhesive strength between basecoat and waterborne primer after humidity testing may be attributed to poor physical binding between basecoat and primer layers. When the film is exposed in a humidity chamber, the film becomes swollen by the penetration of water moisture, which results in poor adhesive strength. After the film is dried at room temperature, the film starts shrinking, by which the adhesive strength between basecoat and primer becomes even worse because no force can prevent such shrinking. To improve adhesive strength, embodiments of the present invention can be applied to the interface between the basecoat and primer layers. In certain embodiments, basecoat and primer compositions are modified by silanes with amine group and epoxide group, respectively. The structure of multiple coating layers using a waterborne primer layer is shown in FIG. 4. A solvent borne etch primer is first sprayed on the surface of substrate panels (such as cold-rolled steel substrate panels), then a waterborne primer (or waterborne hybrid primer) mixed with a silane containing a first functional group, such as an epoxide group, is coated on the surface of the etch primer. Then a basecoat mixed with a silane containing a second functional group reactive with the first functional group, such as an amine group, is coated on the surface of the waterborne primer. Finally, a clearcoat, such as a PU waterborne or solvent borne solution is coated on the surface of the basecoat.

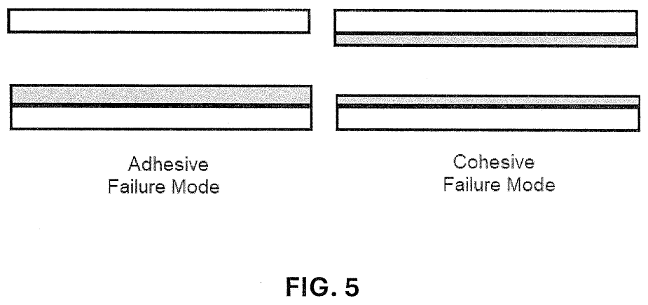

The coating system of the present invention can be used on any two adjacent coating layers, and is particularly helpful at the interface of two waterborne coatings. Coatings can experience failure via two primary methods, adhesion and cohesion. Adhesion is the interlayer strength of bond between adjacent layers, while cohesion is the intralayer strength of each layer. These concepts are illustrated in FIG. 5. By the use of the present invention coating system, the adhesive strength between adjacent layers becomes increased, such that the resulting coating formed has reduced adhesion failure.

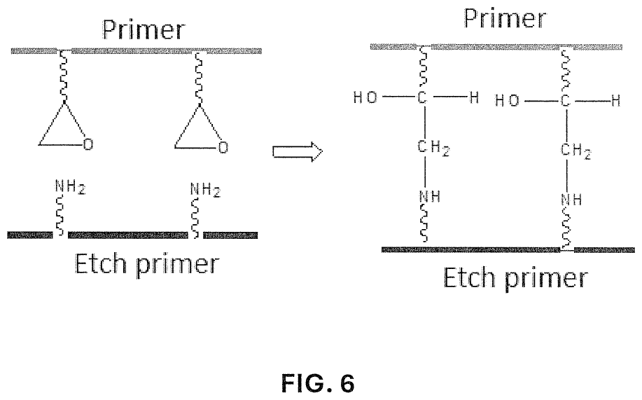

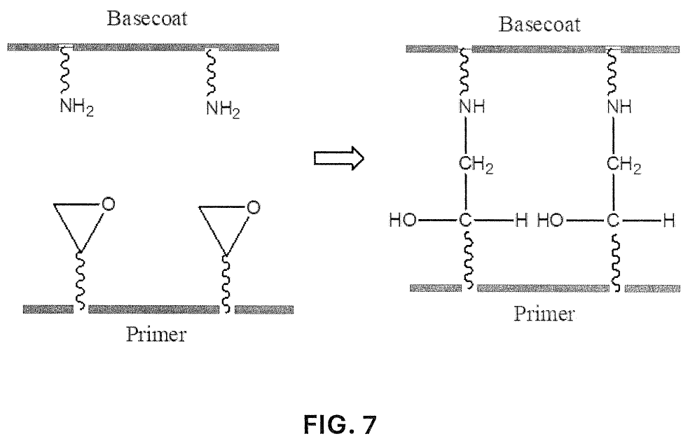

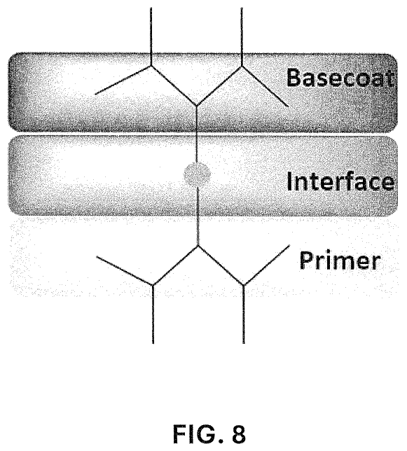

It is also possible to use the coating system of the present invention at the interface of multiple adjacent coating layers in the same multilayered coating, such as between etch primer and primer, between primer and basecoat, and between basecoat and clearcoat. FIG. 6 shows the reactions between an etch primer modified by incorporation of a compound (such as a silane) containing an amine group and a primer modified by incorporation of a compound (such as a silane) containing an epoxy group. FIG. 7 shows the reactions between a primer layer modified by incorporation of a compound (such as a silane) containing an epoxy group and a basecoat layer modified by incorporation of a compound (such as a silane) containing an amine group. FIG. 8 shows a graphical representation of the interface reaction which improves the adhesive strength between primer and basecoat by chemical reaction of such functional silanes in the interface to create covalent bonds between the primer and basecoat layers. FIG. 2, as noted above, shows the reactions between a basecoat layer modified by incorporation of a compound (such as a silane) containing an amine group and a clearcoat layer modified by incorporation of a compound (such as a silane) containing an epoxy group. As can be further envisioned, a full etch primer-primer-basecoat-clearcoat application can be achieved by combining the reactions shown in each of these figures, whereby the etch primer has been modified to contain amine groups on its surface, the primer has been modified to contain epoxy groups on its surfaces, the basecoat has been modified to contain amine groups on its surfaces, and the clearcoat has been modified to contain epoxy groups on its surfaces. In doing so, each successively applied coating layer becomes covalently bonded to the coating layer to which it is applied. This will increase the adhesion between layers throughout the multilayer application.

Waterborne Clearcoat with Strong Adhesive Strength Between Clearcoat Ad Basecoat

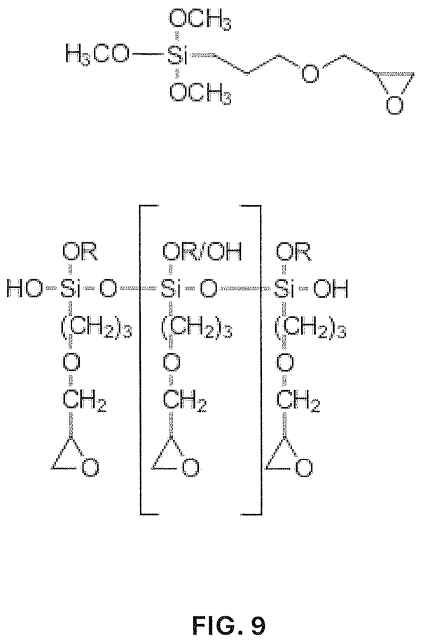

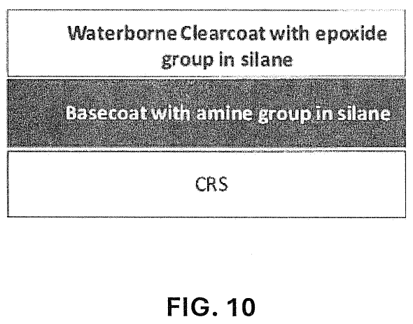

Two waterborne PU clearcoat formulations developed via Michael addition reaction were prepared, each containing epoxy groups via the addition of an epoxy group containing silane compound. Other than the epoxy containing silane compound, the clearcoat formulations were identical. FIG. 9 provides the structures of the two different silanes, with each one being used in a separate clearcoat formulation. These two waterborne clearcoats are sprayed on a substrate (such as cold-rolled steel substrate) coated with a PU basecoat including a silane containing an amine group, respectively. FIG. 10 shows the structure of the basecoat and clearcoat coating layers on the substrate panels.

The performances of waterborne clearcoat modified by functional silane with epoxide group and coated on a basecoat modified by functional silane with amine group showed that the adhesive strength presented by the data from crosshatch test is dramatically improved in the samples of the present invention compared to a conventional basecoat and clearcoat combination. There is no failure mode of adhesion between clearcoat and basecoat after 11 days cured at room temperature. Failure modes that occurred were between basecoat and steel substrate and cohesive failure in the basecoat. Meanwhile, amines having small molecular weight and amine containing oligomers demonstrated similar results in enhancing the adhesive strength between clearcoat and basecoat. Compared with the adhesive strength measured at 11 days to those 3 days cured at room temperature, less failure mode between clearcoat and basecoat is observed. This is because the reaction of amine group with epoxide group continues slowly at room temperature. Meanwhile, the chemical resistance of the film containing an amine with small molecular weight is stronger than that of the film containing an amine with oligomer structure. This is because the reaction rate of amine with small molecular weight is faster than that of amine with oligomer structure since the former can more readily move due to small size compared with the latter with larger size in the system.

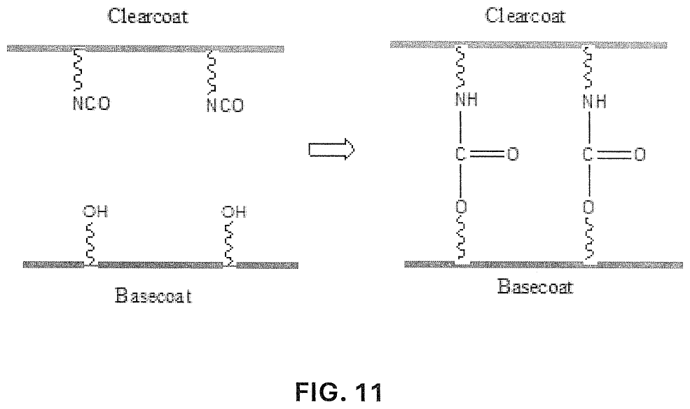

2K PU formed by Michael addition solvent borne clearcoat having isocyanate groups on the surface and waterborne basecoat having amine group containing silane incorporated therein can be used to enhance the adhesive strength between basecoat and clearcoat as well. In this embodiment, the basecoat is mixed with a silane compound containing amine groups, and the clearcoat is mixed with a silane compound containing isocyanate functional groups. These modified basecoat and clearcoat are sprayed sequentially on the substrate panels. Silanes for use in the clearcoat of such an embodiment include 3-isocyanatopropyltriethoxysilane which can react quickly with silane containing an amine group, such as 3-aminopropyltriethoxysilane or aminoethylaminopropylsilsequioxane, in the basecoat. Chemical bonding between clearcoat and basecoat significantly improves the adhesive strength between solvent borne clearcoat and basecoat. FIG. 11 shows the reaction between isocyanate groups on the clearcoat and amine groups on the basecoat. Chemical bonding at the interface of clearcoat and basecoat can significantly improve adhesive strength. Meanwhile, silane with isocyanate group can also react with other compounds having hydroxyl groups in the clearcoat to tightly connect silane with a crosslinked PU network developed by Michael addition.

In this embodiment, the adhesive strength between clearcoat and basecoat is significantly improved as there is no adhesive loss between two layers for the sample developed by the formulations modified with such functionalized silanes. Meanwhile, excellent flexibility of the coating evaluated by mandrel bending and impact strength are also achieved. The DOI of films formed from the embodiment of the present invention is also higher than that of controls.

Furthermore, the adhesive strength between solvent borne clearcoat and basecoat can be improved by adding a silane compound containing epoxide group in clearcoat and a silane compound containing amine group in basecoat. In such embodiments, the adhesive strength between clearcoat and basecoat is also improved and there is no adhesive strength loss. Excellent adhesive strength can be attributed to the reaction of amine and epoxide group at the interface between the basecoat and clearcoat.

In these embodiments, superb chemical resistance with MEK cycle number as high as 300 and mechanical strength related with impact and bending measurement are also achieved.

Use of the present invention in bonding between basecoat and primer layers results provides similar adhesive strength to controls, but using the present invention embodiments, the failure mode between basecoat and primer is changed from being an adhesion failure (failure at the basecoat/primer interface) to being a cohesion failure of the basecoat layer.

The adhesive strength of embodiments of the present invention were evaluated by humidity chamber after the panels are exposed at room temperature for 1 and 24 hours, respectively. The results showed that the adhesive strength loss of the films is increased after humidity chamber testing for the samples exposed at room temperature for 1 hour. But the adhesive strength of some samples actually recovered after the sample was exposed at room temperature for 24 hours. The recovery of adhesive strength is believed to be attributed to the interface between basecoat and primer demonstrating very tight contact after the film shrunk. However, interestingly, the main failure mode of the films modified by functional silanes according to the present invention indicated a cohesive failure within basecoat layer, rather than an adhesion failure at the interface of the layers. It is understood that the force to produce a cohesive failure is much higher than the force to create an adhesive failure between layers, such as basecoat and primer. Therefore, the adhesive strength of the film modified by functional silane according to the invention is better than that using conventional coatings not containing such functional silane modifications.

The performance of anti-corrosion for the panels with the films modified by functional silanes according to the invention were further investigated by salt fog chamber testing. The results showed an exceptional anti-corrosion property as confirmed by analyzing of size of delamination and corrosion on the panels. There was no negative impact on the performance of anti-corrosion of the film modified by functional silanes of embodiments of the present invention.

The surface modification of the various coating layers in embodiments of the present invention can be confirmed by surface analysis using XPS (X-ray photoelectron spectroscopy).

### Characterization

1. Chemical resistance of clearcoat—To check chemical resistance of clearcoat, the panels coated with basecoat and clearcoat are rubbed by one hammer covered with three layers of fiber paper soaked with MEK solvent. The specification of chemical resistance with MEK testing is more than 300 cycles without surface being dissolved and cracked (ASTM D5402-19).

2. Adhesive strength—The adhesive strength of film is evaluated by crosshatch testing (ASTM D3359). The failure mode of film is also assessed based on the observation of peeled film on tape and the substrate. The adhesion strength of film on each layer test is ranked by removing pressure—sensitive tape sticked on the film cut by crosshatch.

3. Impact resistance—Impact resistance of film coated on panels are assessed by ASTM D5420. The data will be repeated twice, and both coated and non-coated sides will be tested and recorded as direct and non-direct impact strength.

4. Conical Mandrel Bend—Flexible capability of film is evaluated by Conical Mandrel Bend (ASTM D522).

5. Optical appearance—Optical apparency of film is evaluated by ASTM D523 for Gloss Retention (20 Deg Gloss) and DOI Retention (Wavescan).

6. Humidity Chamber—Panels with coating edged are put into the humidity chamber with temperature about 30 C for 4 days (GM 14729). The panels are dried with fiber paper after removed from the chamber and exposed at room temperature for 1 and 24 hours, respectively. Then the film is measured for Gloss (20 degree), DOI and crosshatch.

7. Salt fog chamber—Panels with painted at edge and with scratched line in the middle are put at the salt fog chamber with temperature about 30 C for 20 days (ASTM B117). After testing of 20 days, the panels are rinsed with hot water and any loose film removed with metal specula. The size of delamination and corrosion areas are measured, and average data come from the measurement of 20 points.

8. XPS analysis—A PHI 5000 VersaProbe Ill Photoelectron Spectrometer was used for the survey and high-resolution spectra. The excitation source was monochromatic Al Ka radiation (hu=1486.6 eV). All spectra were collected at normal emission angle (45°). Binding energies were referenced against adventitious carbon at 284.8 eV. Simultaneous electron and ion gun neutralizations were used. A FWHM of 1.33±0.09 eV and 1.56±0.17 eV was used for the C—C peak and the C—O peaks, respectively.

The following are exemplary embodiments of the present invention:

Embodiment 1. A coating system, comprising:
a first coating composition comprising a first modified polymer composition containing a first functional group, and
a second coating composition comprising a second modified polymer composition containing a second functional group,
wherein the first functional group and second functional group are reactive with one another, such that upon formation of a first coating layer from the first coating composition and an adjacent second coating layer from the second coating composition, the first functional group and the second functional group react with one another to bind the first coating layer and second coating layer together at their adjacent surfaces.

Embodiment 2. The coating system of Embodiment 1, wherein the first coating composition is a first polyurethane composition.

Embodiment 3. The coating system of Embodiment 2, wherein the first polyurethane composition is a waterborne first polyurethane composition.

Embodiment 4. The coating system of Embodiment 3, wherein the waterborne first polyurethane composition is a waterborne hybrid polyurethane-silane composition.

Embodiment 5. The coating system of Embodiment 2, wherein the first polyurethane composition is a solvent-borne first polyurethane composition.

Embodiment 6. The coating system of any one of Embodiments 1 to 5, wherein the second coating composition is a second polyurethane coating composition.

Embodiment 7. The coating system of Embodiment 6, wherein the second polyurethane composition is a waterborne second polyurethane composition.

Embodiment 8. The coating system of Embodiment 7, wherein the waterborne second polyurethane composition is a waterborne hybrid polyurethane-silane composition.

Embodiment 9. The coating system of Embodiment 6, wherein the second polyurethane composition is a solvent-borne second polyurethane composition.

Embodiment 10. The coating system of any one of Embodiments 1 to 9, wherein the first functional group is a member selected from the group consisting of amino groups, hydroxyl groups, isocyanate groups, and epoxy groups.

Embodiment 11. The coating system of Embodiment 10, wherein the second functional group is a member selected from the group consisting of amino groups, hydroxyl groups, isocyanate groups, and epoxy groups, and is selected to be reactive with the first functional group.

Embodiment 12. The coating system of any one of Embodiments 1 to 11, wherein the first coating layer is a primer layer and the second coating layer is a basecoat layer.

Embodiment 13. The coating system of any one of Embodiments 1 to 11, wherein the first coating layer is a basecoat layer and the second coating layer is a clearcoat layer.

Embodiment 14. A method for improving adhesion between adjacent coating layers, comprising:
forming a first coating layer on at least a portion of a substrate with a first coating composition comprising a modified polymer composition containing a first functional group and curing the first coating layer sufficiently to accept a second coating layer;
forming the second coating layer on the first coating layer with a second coating composition comprising a modified polymer composition containing a second functional group,
curing the first and second coating layers, such that the first functional group and second functional group react with one another to bind the first coating layer and second coating layer to one another at their adjacent surfaces.

Embodiment 15. The method of Embodiment 14, wherein the first coating composition is a first polyurethane composition.

Embodiment 16. The method of Embodiment 15, wherein the first polyurethane composition is a waterborne first polyurethane composition.

Embodiment 17. The coating system of Embodiment 16, wherein the waterborne first polyurethane composition is a waterborne hybrid polyurethane-silane composition.

Embodiment 18. The method of Embodiment 15, wherein the first polyurethane composition is a solvent-borne first polyurethane composition.

Embodiment 19. The method of any one of Embodiments 14 to 18, wherein the second coating composition is a second polyurethane coating composition.

Embodiment 20. The method of Embodiment 19, wherein the second polyurethane composition is a waterborne second polyurethane composition.

Embodiment 21. The coating system of Embodiment 20, wherein the waterborne second polyurethane composition is a waterborne hybrid polyurethane-silane composition.

Embodiment 22. The method of Embodiment 19, wherein the second polyurethane composition is a solvent-borne second polyurethane composition.

Embodiment 23. The method of any one of Embodiments 14 to 22, wherein the first functional group is a member selected from the group consisting of amino groups, hydroxyl groups, isocyanate groups, and epoxy groups.

Embodiment 24. The method of Embodiment 23, wherein the second functional group is a member selected from the group consisting of amino groups, hydroxyl groups, isocyanate groups, and epoxy groups, and is selected to be reactive with the first functional group.

Embodiment 25. The method of any one of Embodiments 14 to 24, wherein the first coating layer is a primer layer and the second coating layer is a basecoat layer.

Embodiment 26. The method of any one of Embodiments 14 to 24, wherein the first coating layer is a basecoat layer and the second coating layer is a clearcoat layer.

Obviously, numerous modifications and variations of the present invention are possible in light of the above teachings. It is therefore to be understood that within the scope of the appended claims, the invention may be practiced otherwise than as specifically described herein.

1. A coating system, comprising:
a first coating composition comprising a first modified polymer composition containing a first functional group, and
a second coating composition comprising a second modified polymer composition containing a second functional group,
wherein the first functional group and second functional group are reactive with one another, such that upon formation of a first coating layer from the first coating composition and an adjacent second coating layer from the second coating composition, the first functional group and the second functional group react with one another to bind the first coating layer and second coating layer together at their adjacent surfaces.

2. The coating system of claim 1, wherein the first coating composition is a first polyurethane composition.

3. The coating system of claim 2, wherein the first polyurethane composition is a waterborne first polyurethane composition.

4. The coating system of claim 1, wherein the second coating composition is a second polyurethane coating composition.

5. The coating system of claim 4, wherein the second polyurethane composition is a waterborne second polyurethane composition.

6. The coating system of claim 5, wherein the waterborne second polyurethane composition is a waterborne hybrid polyurethane-silane composition.

7. The coating system of claim 4, wherein the second polyurethane composition is a solvent-borne second polyurethane composition.

8. The coating system of claim 1, wherein the first functional group is a member selected from the group consisting of amino groups, hydroxyl groups, isocyanate groups, and epoxy groups.

9. The coating system of claim 8, wherein the second functional group is a member selected from the group consisting of amino groups, hydroxyl groups, isocyanate groups, and epoxy groups, and is selected to be reactive with the first functional group.

10. The coating system of claim 1, wherein the first coating layer is a primer layer and the second coating layer is a basecoat layer.

11. The coating system of claim 1, wherein the first coating layer is a basecoat layer and the second coating layer is a clearcoat layer.

12. A method for improving adhesion between adjacent coating layers, comprising:
forming a first coating layer on at least a portion of a substrate with a first coating composition comprising a modified polymer composition containing a first functional group and curing the first coating layer sufficiently to accept a second coating layer;
forming the second coating layer on the first coating layer with a second coating composition comprising a modified polymer composition containing a second functional group,
curing the first and second coating layers, such that the first functional group and second functional group react with one another to bind the first coating layer and second coating layer to one another at their adjacent surfaces.

13. The method of claim 12, wherein the first coating composition is a first polyurethane composition.

14. The method of claim 13, wherein the first polyurethane composition is a waterborne first polyurethane composition.

15. The method of claim 12, wherein the second coating composition is a second polyurethane coating composition.

16. The method of claim 15, wherein the second polyurethane composition is a waterborne second polyurethane composition.

17. The coating system of claim 16, wherein the waterborne second polyurethane composition is a waterborne hybrid polyurethane-silane composition.

18. The method of claim 16, wherein the second polyurethane composition is a solvent-borne second polyurethane composition.

19. The method of claim 12, wherein the first functional group is a member selected from the group consisting of amino groups, hydroxyl groups, isocyanate groups, and epoxy groups.

20. The method of claim 19, wherein the second functional group is a member selected from the group consisting of amino groups, hydroxyl groups, isocyanate groups, and epoxy groups, and is selected to be reactive with the first functional group.

21. The method of claim 12, wherein the first coating layer is a primer layer and the second coating layer is a basecoat layer.

22. The method of claim 12, wherein the first coating layer is a basecoat layer and the second coating layer is a clearcoat layer.
